(19) United States
(12) Patent Application Publication
(10) Pub. No.: US 2025/0349131 A1
(43) Pub. Date: Nov. 13, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Cho Rong Ryu, Hwaseong-Si (KR); Dae Sung Hwang, Hwaseong-Si (KR)

(21) Appl. No.: 18/965,762

(22) Filed: Dec. 2, 2024

(30) Foreign Application Priority Data
May 10, 2024 (KR) 10-2024-0062037

(51) Int. Cl. G06V 20/56; G06V 10/36; G06V 10/75

(52) U.S. Cl. CPC G06V 20/588; G06V 10/36; G06V 10/751

(57) ABSTRACT

The present disclosure relates to a vehicle control apparatus and a method thereof. The vehicle control apparatus may include a camera, a memory configured to store map information, and a processor. The processor may obtain, via the camera, an image of an external environment of a vehicle, determine one or more line segments associated with a traffic line in the image, and filter at least one of the one or more line segments or the map information. Filtering may be based on at least one of an attribute, an angle, or a distance of each of the one or more line segments. The processor may further compare the map information with candidate line segments, wherein the candidate line segments exclude filtered line segments from the one or more line segments, and control, based on the comparison, an operation of the vehicle.

### CROSS-REFERENCE TO RELATED APPLICATION

This application claims the benefit of priority to Korean Patent Application No. 10-2024-0062037, filed in the Korean Intellectual Property Office on May 10, 2024, the entire contents of which are incorporated herein by reference.

### TECHNICAL FIELD

The present disclosure relates to a vehicle control apparatus and a method thereof.

### BACKGROUND

When a vehicle is in a driving assistance mode or an autonomous driving mode, the vehicle may receive a map (e.g., a high-definition (HD) map) to estimate a location and may use a map matching algorithm that matches the map with sensor values.

A driving route may be created by performing global path planning based on the location of the vehicle estimated in this way, and autonomous driving may be performed by controlling the vehicle along the created driving route.

### SUMMARY

The present disclosure was made to solve the above-mentioned problems occurring in at least some implementations while advantages achieved by those implementations are maintained intact.

An aspect of the present disclosure provides a vehicle control apparatus for securing robust line map matching performance by filtering lines recognized by a camera, and a method thereof.

An aspect of the present disclosure provides a vehicle control apparatus for stably controlling the operation of a vehicle by filtering misrecognized lines and performing map matching, and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a camera; a memory configured to store map information; and a processor. The processor may be configured to: obtain, via the camera, an image of an external environment of a vehicle; determine one or more line segments associated with a traffic line in the image; and filter at least one of the one or more line segments or the map information. Filtering may be based on at least one of an attribute, an angle, or a distance of each of the one or more line segments. The processor may be further configured to: compare the map information with candidate line segments. The candidate line segments may exclude filtered line segments from the one or more line segments. The processor may be further configured to control, based on the comparison, an operation of the vehicle.

The processor may be configured to filter at least one of the one or more line segments or the map information by: determining, based on the one or more line segments, a first width of a traffic lane; determining, based on map lines in the map information, a second width of the traffic lane; and filtering the at least one of the one or more line segments or the map information further based on comparing the first width with the second width.

The processor may be configured to filter at least one of the one or more line segments or the map information by: filtering the at least one of the one or more line segments or the map information further based on at least one of: a type of each of the one or more line segments, a heading direction of each of the one or more line segments, a distance between the one or more line segments, a line of a widening traffic lane on which the vehicle is traveling, or a lane width.

The processor may be configured to filter at least one of the one or more line segments or the map information by: filtering the at least one of the one or more line segments or the map information further based on a type of each of the one or more line segments being different from a type of a map line in the map information.

The processor may be configured to filter at least one of the one or more line segments or the map information by: determining, among the one or more line segments, a partial line segment; determining, based on the map information, a partial map line corresponding to the partial line segment; and filtering the at least one of the one or more line segments or the map information further based on an angle between the partial line segment and the partial map line exceeding a threshold angle.

The processor may be configured to filter at least one of the one or more line segments or the map information by: determining, among the one or more line segments, partial line segments; determining, based on the map information, partial map lines respectively corresponding to the partial line segments; and filtering the at least one of the one or more line segments or the map information further based on an average value of angles between the partial map lines and the partial line segments exceeding a threshold angle.

The processor may be configured to filter at least one of the one or more line segments or the map information by: filtering the at least one of the one or more line segments or the map information further based on at least a threshold quantity of the one or more line segments being within a threshold distance from respective partial map lines in the map information.

The processor may be configured to filter at least one of the one or more line segments or the map information by: filtering the at least one of the one or more line segments or the map information further based on: a lane on which the vehicle is traveling being widening, a distance between the vehicle and a map line in the map information exceeding a threshold distance, and partial line segments, of the one or more line segments, exceeding a threshold angle relative to a longitudinal axis of the vehicle.

The processor may be configured to filter at least one of the one or more line segments or the map information by: determining, based on a distance between a reference point and the one or more line segments, a sensor-based average lane width; determining, based on a distance between the reference point and map lines in the map information, a map-based average lane width; and filtering the at least one of the one or more line segments or the map information further based on comparing the sensor-based average lane width with the map-based average lane width. The reference point may be a threshold distance away from a left traffic line of the vehicle.

The processor may be configured to filter at least one of the one or more line segments or the map information by: filtering the at least one of the one or more line segments or the map information further based on: a difference between the sensor-based average lane width and the map-based average lane width exceeding a first threshold ratio by at least a threshold margin, or the difference between the sensor-based average lane width and the map-based average lane width exceeding a second threshold ratio.

The processor may be further configured to: based on a difference between a sensor-based average lane width and a map-based average lane width exceeding a first threshold ratio by at least a threshold margin or exceeding a second threshold ratio, and further based on a traffic lane on which the vehicle is traveling being an outermost lane of a road, controlling the operation of the vehicle based on the one or more line segments or the map information.

According to one or more example embodiments of the present disclosure, a vehicle control method may include: obtaining, by a processor and via a camera, an image of an external environment of a vehicle; and determining one or more line segments associated with a traffic line in the image; filtering at least one of the one or more line segments or map information stored in a memory. Filtering may be based on at least one of an attribute, an angle, or a distance of each of the one or more line segments. The vehicle control method may further include comparing the map information with candidate line segments. The candidate line segments may exclude filtered line segments from the one or more line segments. The vehicle control method may further include controlling, based on the comparison, an operation of the vehicle.

Filtering at least one of the one or more line segments or the map information may include: determining, based on the one or more line segments, a first width of a traffic lane; determining, based on map lines in the map information, a second width of the traffic lane; and filtering the at least one of the one or more line segments or the map information further based on comparing the first width with the second width.

Filtering at least one of the one or more line segments or the map information may include: filtering the at least one of the one or more line segments or the map information further based on at least one of: a type of each of the one or more line segments, a heading direction of each of the one or more line segments, a distance between the one or more line segments, a line of a widening traffic lane on which the vehicle is traveling, or a lane width.

Filtering at least one of the one or more line segments or the map information may include: filtering the at least one of the one or more line segments or the map information further based on a type of each of the one or more line segments being different from a type of a map line in the map information.

Filtering at least one of the one or more line segments or the map information may include: determining, among the one or more line segments, a partial line segment; determining, based on the map information, a partial map line corresponding to the partial line segment; and filtering the at least one of the one or more line segments or the map information further based on an angle between the partial line segment and the partial map line exceeding a threshold angle.

Filtering at least one of the one or more line segments or the map information may include: determining, among the one or more line segments, partial line segments; determining, based on the map information, map partial lines respectively corresponding to the partial line segments; and filtering the at least one of the one or more line segments or the map information further based on an average value of angles between the partial map lines and the partial line segments exceeding a threshold angle.

Filtering at least one of the one or more line segments or the map information may include: filtering the at least one of the one or more line segments or the map information further based on at least a threshold quantity of the one or more line segments being within a threshold distance from respective partial map lines in the map information.

Filtering at least one of the one or more line segments or the map information may include: filtering the at least one of the one or more line segments or the map information further based on: a lane on which the vehicle is traveling being widening, a distance between the vehicle and a map line in the map information exceeding a threshold distance, and partial line segments, of the one or more line segments, exceeding a threshold angle relative to a longitudinal axis of the vehicle.

Filtering at least one of the one or more line segments or the map information may include: determining, based on a distance between a reference point and the one or more line segments, a sensor-based average lane width; determining, based on a distance between the reference point and map lines in the map information, a map-based average lane width; and filtering the at least one of the one or more line segments or the map information further based on comparing the sensor-based average lane width with the map-based average lane width. The reference point may be a threshold distance away from a left traffic line of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus;

FIG. 2 shows an example of a process of outputting a location of a vehicle;

FIG. 3 shows an example of performing data filtering;

FIG. 4 shows an example of performing data filtering;

FIG. 5 shows an example of a table representing a final line filtered by selecting a filtering candidate;

FIG. 6 shows an example of a flowchart associated with a vehicle control method; and

FIG. 7 shows a computing system associated with a vehicle control apparatus or vehicle control method.

### DETAILED DESCRIPTION

Hereinafter, one or more example embodiments of the present disclosure will be described in detail with reference to the accompanying drawings. In adding reference numerals to components of each drawing, it should be noted that the same components include the same reference numerals, although they are indicated on another drawing. Furthermore, in describing the example embodiments of the present disclosure, detailed descriptions associated with well-known functions or configurations will be omitted if they may make subject matters of the present disclosure unnecessarily obscure.

In describing elements of one or more example embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., filtering line segments and map information) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., filtering line segments and map information) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., filtering line segments and map information) described herein.

Minimum risk maneuver (MRM) operation(s) may also be controlled, for example, based on one or more features (e.g., filtering line segments and map information) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., filtering line segments and map information) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring line departure warning sensor, parking sensor, light traction sensor, rain sensor, control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., filtering line segments and map information) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

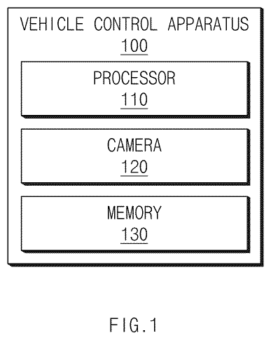

Hereinafter, one or more example embodiments of the present disclosure will be described in detail with reference to FIGS. 1 to 7.

FIG. 1 shows an example of a block diagram associated with a vehicle control apparatus.

Referring to FIG. 1, a vehicle control apparatus 100 may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 may include a processor 110, a camera 120, and a memory 130. The processor 110, the camera 120, or the memory 130 may be electronically and/or operably coupled with each other by an electronical component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, the present disclosure is not limited thereto. For example, some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The camera 120 included in the vehicle control apparatus 100 may include one or more optical sensors (e.g., a charged coupled device (CCD) sensor or a complementary metal oxide semiconductor (CMOS) sensor) that generate electrical signals indicating the color and/or brightness of light. Optical sensors included in the camera 120 may be arranged in a form of a 2-dimensional array. The camera 120 may obtain electrical signals from a plurality of optical sensors substantially simultaneously and may generate images or frames, each of which corresponds to light reaching the optical sensors in two-dimensional grids and each of which includes a plurality of pixels arranged in two dimensions. For example, photo data captured by using the camera 120 may refer to a plurality of images obtained from the camera 120. For example, video data captured by using the camera 120 may mean the sequence of a plurality of images obtained from the camera 120 at a designated frame rate.

The memory 130 of the vehicle control apparatus 100 may include a hardware component for storing data and/or instructions that are to be input and/or output to the processor 110 of the vehicle control apparatus 100.

For example, the memory 130 may include a volatile memory including a random-access memory (RAM), or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

For example, map information may be stored in the memory 130. For example, the map information may include at least one of a high definition (HD) map, or a general map, or any combination thereof. However, the present disclosure is not limited to the above description. For example, the map information may include map lines.

The processor 110 of the vehicle control apparatus 100 may obtain an image through the camera 120. The image may represent an external environment of the vehicle. For example, the processor 110 may obtain pieces of line segment data (e.g., one or more line segments) associated with a line (e.g., one or more traffic lines) within the image obtained through the camera 120. For example, the pieces of line segment data associated with a line may include pieces of data for indicating line segments respectively corresponding to lines. For example, the pieces of line segment data may include line segment lines.

The processor 110 may perform data filtering on at least one of pieces of line segment data, or map information, or any combination thereof based on a condition associated with at least one of an attribute, an angle, or a distance, or any combination thereof of each of the pieces of line segment data.

The processor 110 may perform first data filtering on at least one of the pieces of line segment data, or the map information, or any combination thereof based on the condition associated with at least one of an angle, or a distance, or any combination thereof.

For example, the processor 110 may perform the first data filtering, which filters map lines included in the map information, based on the condition associated with at least one of a distance between the vehicle and the map lines identified in the map information, or an angle formed between a heading direction of the vehicle and each of the map lines, or any combination thereof.

For example, the processor 110 may perform the first data filtering, which filters pieces of line segment data, based on a condition associated with at least one of a distance between the vehicle and line segment lines identified in the line segment data, or an angle formed between the heading direction of the vehicle and each of the line segment lines, or any combination thereof.

The processor 110 may perform second data filtering on each of the pieces of line segment data, based on the attribute of each of the pieces of line segment data.

For example, the processor 110 may calculate a first width of a lane based on line segment lines identified by the pieces of line segment data. For example, the processor 110 may calculate a second width of a lane based on map lines identified in the map information. For example, the processor 110 may determine whether to perform second data filtering, by comparing the first width with the second width.

For example, the processor 110 may perform the second data filtering based on at least one of the type of each of the pieces of line segment data, a heading direction of each of the pieces of line segment data, a distance between pieces of line segment data, a line identified if a lane on which the vehicle is driving is expanded (e.g., a line of a widening traffic lane on which the vehicle is traveling), or a lane width, or any combination thereof.

For example, the type of each of the pieces of line segment data may be associated with whether the line is identified as a single line, or whether the line is identified as double lines. For example, the type of each of the pieces of line segment data may include at least one of a single line type, or a double line type, or any combination thereof.

For example, the processor 110 may perform the second data filtering based on the type of each of the pieces of line segment data being different from the type of the map line identified in the map information. For example, the processor 110 may perform the second data filtering based on the type of each of the pieces of line segment data being identified as a single line type, and the type of the map line being identified as a double line type.

For example, the processor 110 may identify partial line segment data among the pieces of line segment data. For example, the partial line segment data may include at least some of the pieces of line segment data.

For example, the processor 110 may identify a partial map line corresponding to the partial line segment data in the map information. For example, the partial map line may include at least some of the map lines included in the map information.

For example, the processor 110 may identify an angle between partial line segment data and the partial map line. For example, the processor 110 may determine whether the angle between the partial line segment data and the partial map line exceeds a first designated angle (e.g., a threshold angle). For example, the first designated angle may include approximately 2.25 degrees.

For example, the processor 110 may perform the second data filtering based on the angle between the partial line segment data and the partial map line exceeding the first designated angle.

For example, the processor 110 may bypass the execution of the second data filtering based on the angle between the partial line segment data and the partial map line being smaller than or equal to the first designated angle.

For example, the processor 110 may identify angles between partial map lines respectively corresponding to pieces of partial line segment data and the pieces of partial line segment data. For example, the processor 110 may determine whether an average value of the angles between the partial map lines respectively corresponding to the pieces of partial line segment data and the pieces of partial line segment data exceeds a second designated angle (e.g., a threshold angle). For example, the second designated angle may include approximately 1.5 degrees.

For example, the processor 110 may perform the second data filtering based on the average value of the angles between the partial map lines respectively corresponding to the pieces of partial line segment data and the pieces of partial line segment data exceeding the second designated angle.

For example, the processor 110 may bypass the second data filtering based on the average value of the angles between the partial map lines respectively corresponding to the pieces of partial line segment data and the pieces of partial line segment data being smaller than or equal to the second designated angle.

For example, the processor 110 may perform the second data filtering based on an angle difference between left line segment data corresponding to a left line and right line segment data corresponding to a right line exceeding approximately 3 degrees.

For example, the processor 110 may determine whether at least one of the pieces of line segment data and the number of partial map lines identified in the map information are greater than or equal to the designated number within a first designated distance. For example, the first designated distance may include approximately 1 meter. For example, the designated number may include approximately 2.

For example, the processor 110 may perform the second data filtering based on at least one of the pieces of line segment data and partial map lines identified in the map information being identified within the first designated distance by the designated number or more.

For example, the processor 110 may bypass the second data filtering based on at least one of the pieces of line segment data and partial map lines identified in the map information being identified within the first designated distance by smaller than the designated number.

For example, the processor 110 may identify partial line segment data indicating that a distance between the vehicle and a map line exceeds a second designated distance if a lane is expanded, and a third designated angle is exceeded based on a forward-facing axis of the vehicle, from among the pieces of line segment data. For example, the second designated distance may include approximately 2.5 meters. For example, the third designated angle may include approximately 2 degrees.

For example, the processor 110 may create a reference point spaced apart from a left line of the vehicle by a third designated distance. For example, the processor 110 may obtain a sensor-based average lane width by identifying a length between the reference point and the pieces of line segment data based on creating the reference point spaced apart from the left line of the vehicle by the third designated distance.

For example, the processor 110 may obtain a map-based average lane width by identifying the length between the reference point and the map lines identified in the map information.

For example, the processor 110 may perform the second data filtering based on comparing the sensor-based average lane width with the map-based average lane width.

For example, the processor 110 may determine whether a difference between the sensor-based average lane width and the map-based average lane width exceeds a first designated ratio. For example, the processor 110 may determine whether a difference by which the difference between the sensor-based average lane width and the map-based average lane width exceeds the first designated ratio is greater than or equal to the designated number. For example, the first designated ratio may include approximately 14%. For example, the designated number may include approximately 3.

For example, the processor 110 may determine whether the difference between the sensor-based average lane width and the map-based average lane width exceeds a second designated ratio. For example, the second designated ratio may include approximately 7%.

For example, the processor 110 may perform the second data filtering based on a difference, by which the difference between the sensor-based average lane width and the map-based average lane width exceeds the first designated ratio, being greater than or equal to the designated number, or the difference between the sensor-based average lane width and the map-based average lane width exceeding the second designated ratio.

For example, the processor 110 may not perform the second data filtering based on a lane being the most side lane of a road if the difference, by which the difference between the sensor-based average lane width and the map-based average lane width exceeds the first designated ratio, is greater than or equal to the designated number, or the difference between the sensor-based average lane width and the map-based average lane width exceeds the second designated ratio. For example, not performing the second data filtering may include bypassing the second data filtering.

The processor 110 may perform at least one of the first data filtering, or the second data filtering, or any combination thereof. For example, the processor 110 may delete pieces of filter line segment data filtered by the first data filtering and the second data filtering. For example, the processor 110 may apply a designated algorithm to pieces of candidate line segment data excluding the pieces of filter line segment data and the map information based on deleting the pieces of filter line segment data filtered by the first data filtering and the second data filtering. For example, the designated algorithm may include an iterative closest point (ICP) algorithm.

For example, the processor 110 may perform matching between the map information and the pieces of candidate line segment data, by applying the designated algorithm to pieces of candidate line segment data excluding the pieces of filter line segment data and the map information based on deleting the pieces of filter line segment data filtered by the first data filtering and the second data filtering.

The processor 110 may control the operation of the vehicle by using a coordinate system expressing a location where the vehicle is driving, based on performing the matching between the map information and the candidate pieces of line segment data.

For example, the coordinate system expressing the location where the vehicle is driving may include at least one of a vehicle coordinate system expressed around the vehicle, or an absolute coordinate system expressed around a map, or any combination thereof.

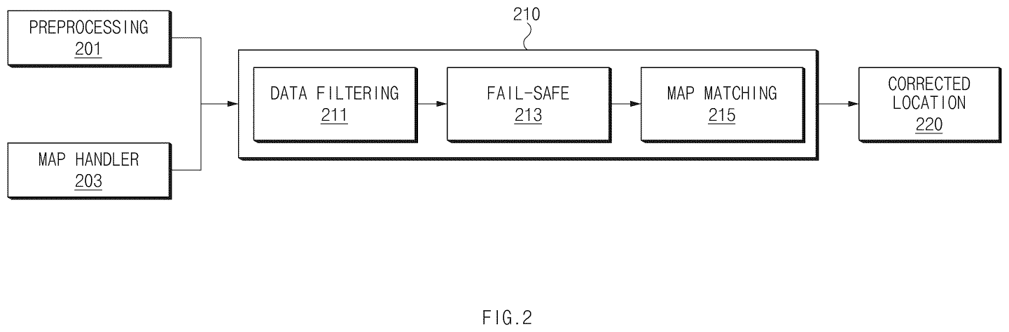

FIG. 2 shows an example of a process of outputting a location of a vehicle.

Referring to FIG. 2, a processor (e.g., the processor 110 of FIG. 1) of a vehicle control apparatus (e.g., the vehicle control apparatus 100 of FIG. 1) may perform preprocessing 201 on sensor data. For example, the sensor data may include an image obtained from a camera. For example, the sensor data may include a line segment corresponding to a line within the image obtained from the camera.

The processor may identify a location of the vehicle by using a map handler 203. For example, the processor may identify at least one of a road, a lane, or a line, or any combination thereof by using the map handler 203.

The processor may perform a map matching lane marker 210. For example, while performing the map matching lane marker 210, the processor may perform at least one of data filtering 211, fail-safe 213, or map matching 215, or any combination thereof.

The processor may output a corrected location 220 of the vehicle based on performing the map matching lane marker 210.

For example, the processor may output the corrected location 220 of the vehicle while expressing the corrected location 220 on an absolute coordinate system.

For example, the processor may control the operation of the vehicle based on expressing the corrected location 220 of the vehicle on the absolute coordinate system.

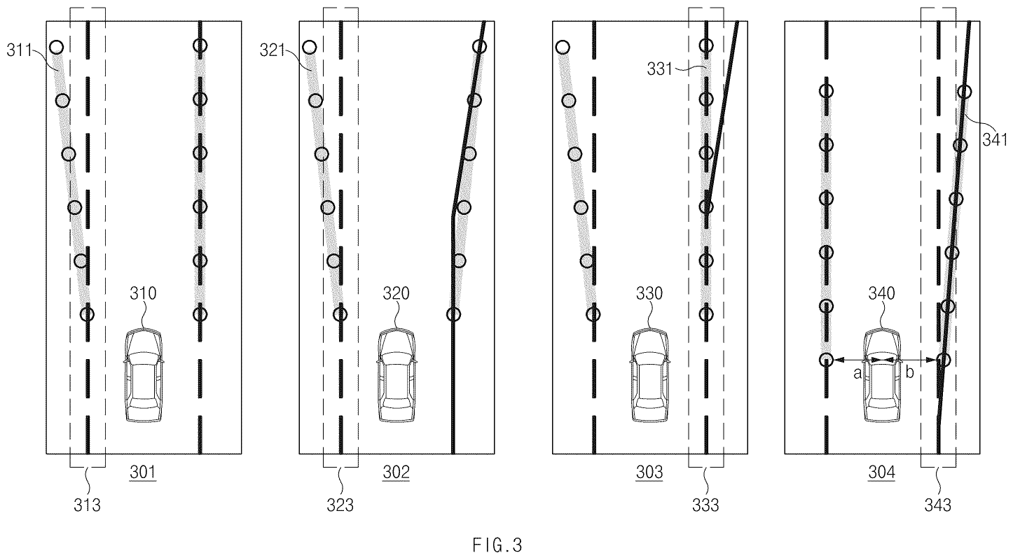

FIG. 3 shows an example of performing data filtering.

Referring to FIG. 3, at least one of a first example 301, a second example 302, a third example 303, or a fourth example 304, or any combination thereof may include at least some processes included in second data filtering.

For example, the first example 301 may be referred to as “type filtering”. For example, the second example 302 may be referred to as “heading filtering”. For example, the third example 303 may be referred to as “double line filtering”. For example, the fourth example 304 may be referred to as “far & slanted filtering”.

Referring to the first example 301, a processor (e.g., the processor 110 of FIG. 1) of a vehicle control apparatus (e.g., the vehicle control apparatus 100 of FIG. 1) may identify the surrounding environment of a vehicle 310. For example, the processor may identify lines 313 in map information. For example, the processor may identify pieces of line segment data 311 corresponding to the lines 313.

For example, the processor may identify types of the lines 313. For example, the processor may identify types of the pieces of line segment data 311.

For example, the processor may determine whether the types of the lines 313 are the same as the types of the pieces of line segment data 311. The processor may bypass the second data filtering based on the types of the lines 313 being the same as the types of the pieces of line segment data 311. For example, the processor may perform the second data filtering based on the types of the lines 313 being different from the types of the pieces of line segment data 311.

Referring to the second example 302, the processor may identify directions of pieces of line segment data 321 based on the forward-facing axis of a vehicle 320. The processor may identify the directions of lines 323 based on the forward-facing axis of the vehicle 320.

For example, the processor may identify an angle between pieces of line segment data 321 and the lines 323 respectively corresponding to the pieces of line segment data 321.

For example, the processor may perform the second data filtering based on the number of line segments where angles between the pieces of line segment data 321 and the lines 323 respectively corresponding to the pieces of line segment data 321 exceed a designated angle (e.g., approximately 3 degrees) is greater than or equal to the designated number (e.g., approximately 3).

For example, the processor may identify an average value of the angles between the pieces of line segment data 321 and the lines 323 respectively corresponding to the pieces of line segment data 321. For example, the processor may perform the second data filtering based on the average value of the angles between the pieces of line segment data 321 and the lines 323 respectively corresponding to the pieces of line segment data 321 exceeding the designated angle (e.g., approximately 1.5 degrees).

Referring to the third example 303, the processor may identify lines 333 that are present around a vehicle 330. For example, the processor may identify the lines 333, which are present around the vehicle 330, based on map information.

For example, the processor may identify pieces of line segment data 331 based on an image obtained from a camera. For example, the processor may determine whether at least some of the pieces of line segment data 331 is present within a designated distance (e.g., about 1 meter) from the lines 333.

For example, the processor may perform the second data filtering based on the pieces of line segment data 331 being present within the designated distance from the lines 333 by the designated number (e.g., about 2).

Referring to the fourth example 304, the processor may determine whether a road on which a vehicle 340 is driving is expanded. For example, the processor may perform the second data filtering based on a minimum lateral distance between lines 343 and pieces of line segment data 341 exceeding approximately 2.5 meters, and an average angle of the pieces of line segment data 341 exceeding about 2 degrees, if the road on which the vehicle 340 is driving is expanded.

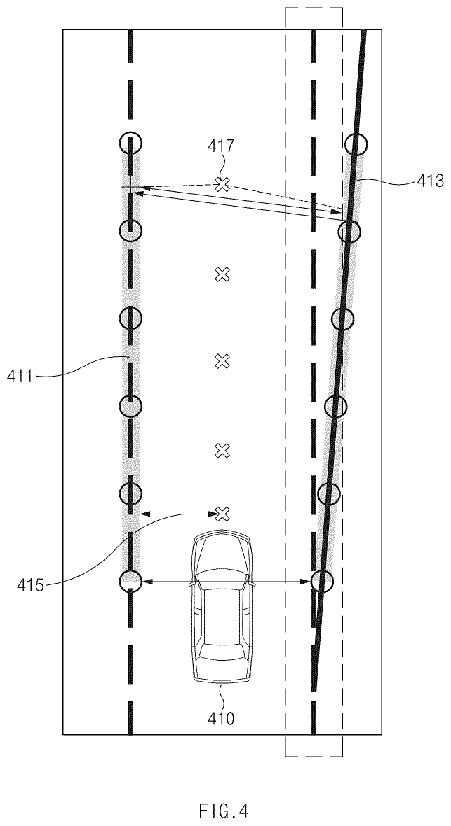

FIG. 4 shows an example of performing data filtering.

Referring to example 401 of FIG. 4, a processor (e.g., the processor 110 of FIG. 1) of a vehicle control apparatus (e.g., the vehicle control apparatus 100 of FIG. 1) may identify the width of a lane in which a vehicle 410 is driving.

For example, the processor may generate a reference point 417 by moving center points of pieces of line segment data corresponding to left lines 411 to the right by half a designated distance 415.

For example, the processor may obtain a sensor-based average lane width by obtaining the foot of a perpendicular line above the pieces of sensor data corresponding to right lines 413 based on the reference point 417.

For example, the processor may obtain the map-based average lane width by identifying lines of map information that are closest to the sensor-based average lane width.

For example, the processor may identify that a difference between the sensor-based average lane width and the map-based average lane width exceeds a designated ratio (e.g., approximately 14%), based on the reference point 417 and may perform second data filtering based on a difference exceeding the designated ratio being greater than or equal to the designated number (e.g., about 3).

For example, the processor may perform second data filtering based on the difference between the sensor-based average lane width and the map-based average lane width exceeding the designated ratio (e.g., approximately 7%), on the basis of the reference point 417.

The processor may perform road boundary filtering if the difference between the sensor-based average lane width and the map-based average lane width exceeds the first designated ratio (e.g., approximately 7%) based on the reference point 417, and a lane in which the vehicle 410 is driving is the first lane or the last lane even though it is smaller than or equal to the second designated ratio (e.g., about 14%).

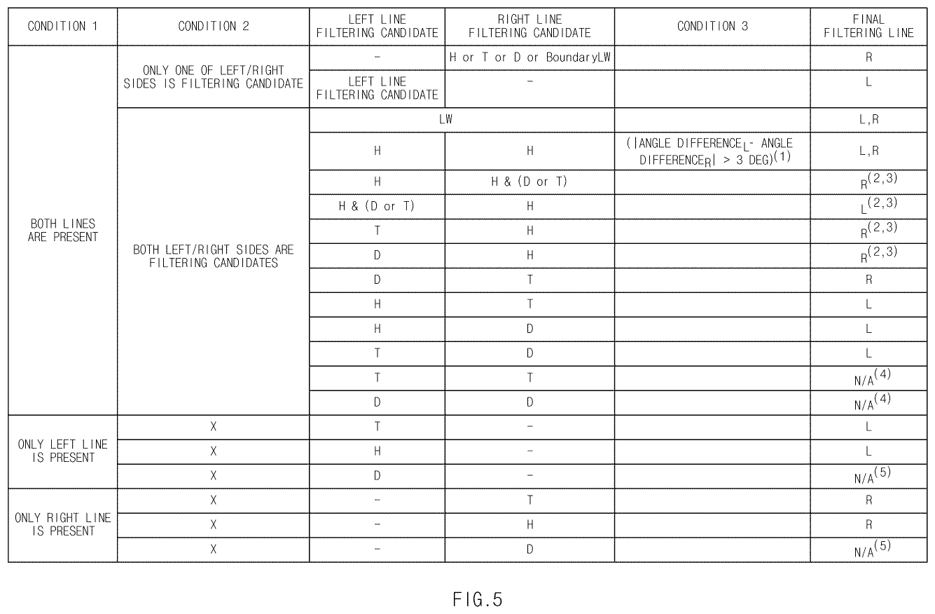

FIG. 5 shows an example of a table representing a final line filtered by selecting a filtering candidate.

Referring to FIG. 5, a processor (e.g., the processor 110 in FIG. 1) included in a vehicle control apparatus (e.g., the vehicle control apparatus 100 in FIG. 1) may determine whether at least one of pieces of line segment data, or a map line, or any combination thereof satisfies a condition.

For example, in the table, ‘H’ may mean heading filtering. For example, in the table, ‘T’ may mean type filtering. For example, in the table, ‘D’ may mean double line filtering. For example, in the table, BoundaryLW may mean road boundary filtering.

For example, in the table, ‘R’ may mean a right line. For example, in the table, ‘L’ may mean a left line. For example, in the table, N/A may mean not performing filtering.

For example, a first condition may be associated with a location where a line is present based on a vehicle. For example, the first condition may be associated with whether a line is present on both sides of the vehicle, whether only the left line is present based on the vehicle, and whether only the right line is present based on the vehicle.

For example, if the first condition is satisfied, the processor may determine whether at least one of pieces of line segment data, or the map line, or any combination thereof satisfies a second condition.

For example, the second condition may be associated with whether only one of both lines is a filtering candidate, and whether both lines are filtering candidates.

Referring to the table, the processor may perform (1) under condition 3 to prevent a situation where a heading filtering condition of a left line and a right line is satisfied due to incorrect heading estimation.

For example, in (2, 3), the processor may use even one misrecognized line for location estimation because the line map matching results are relatively accurate compared to other lateral fusion sources.

For example, in (2, 3), because an error bound is present even though the processor uses a line satisfying a condition of double line filtering or type filtering, the processor may use this.

For example, in (4), because it is difficult to determine which line is more accurate, the processor may use both lines without performing any filtering.

For example, in (5), because the mis-recognition probability of double line filtering is lower than the mis-recognition probability of each of type filtering and heading filtering, the processor may use this.

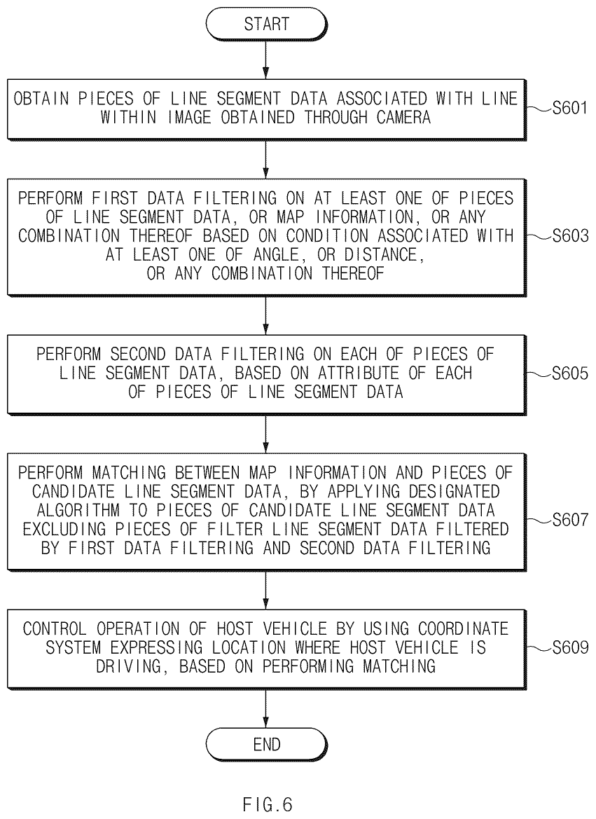

FIG. 6 shows an example of a flowchart associated with a vehicle control method.

Hereinafter, it is assumed that the vehicle control apparatus 100 of FIG. 1 performs the process of FIG. 6. In addition, in a description of FIG. 6, it may be understood that an operation described as being performed by an apparatus is controlled by the processor 110 of the vehicle control apparatus 100.

At least one of operations of FIG. 6 may be performed by the vehicle control apparatus 100 of FIG. 1. At least one of operations of FIG. 6 may be performed by the processor 110 of FIG. 1. Each of the operations in FIG. 6 may be performed sequentially, but is not necessarily sequentially performed. For example, the order of operations may be changed, and at least two operations may be performed in parallel.

Referring to FIG. 6, in S601, a vehicle control method may include an operation of obtaining pieces of line segment data associated with a line within an image obtained through a camera.

In S603, the vehicle control method may include an operation of performing first data filtering on at least one of pieces of line segment data, or map information, or any combination thereof based on a condition associated with at least one of an angle, or a distance, or any combination thereof.

For example, the vehicle control method may include an operation of calculating a first width of a lane based on line segment lines identified by the pieces of line segment data. For example, the vehicle control method may include an operation of calculating a second width of the lane based on map lines identified in the map information. For example, the vehicle control method may include an operation of determining whether to perform second data filtering, by comparing the first width with the second width.

In S605, the vehicle control method may include an operation of performing second data filtering on each of the pieces of line segment data, based on the attribute of each of the pieces of line segment data.

For example, the vehicle control method may include an operation of performing the second data filtering based on at least one of the type of each of the pieces of line segment data, a heading direction of each of the pieces of line segment data, a distance between pieces of line segment data, a line identified if a lane on which the vehicle is driving is expanded, or a lane width, or any combination thereof.

For example, the vehicle control method may include an operation of performing the second data filtering based on the type of each of the pieces of line segment data being different from the type of the map line identified in the map information.

For example, the vehicle control method may include an operation of identifying partial line segment data among the pieces of line segment data. For example, the vehicle control method may include an operation of identifying a partial map line corresponding to the partial line segment data in the map information. For example, the vehicle control method may include an operation of performing the second data filtering based on an angle between the partial line segment data and the partial map line exceeding a first designated angle.

For example, the vehicle control method may include an operation of performing the second data filtering based on the average value of angles between the partial map lines respectively corresponding to the pieces of partial line segment data and the pieces of partial line segment data exceeding a second designated angle.

For example, the vehicle control method may include an operation of performing the second data filtering based on at least one of the pieces of line segment data and partial map lines identified in the map information being identified within the first designated distance by the designated number or more.

For example, the vehicle control method may include an operation of performing the second data filtering based on identifying partial line segment data indicating that a distance between the vehicle and the map line exceeds a second designated distance if the lane is expanded, and a third designated angle is exceeded based on a forward-facing axis of the vehicle, from among the pieces of line segment data.

For example, the vehicle control method may include an operation of obtaining a sensor-based average lane width by identifying a length between a reference point and the pieces of line segment data based on creating the reference point spaced apart from the left line of the vehicle by the third designated distance. For example, the vehicle control method may include an operation of obtaining a map-based average lane width by identifying the length between the reference point and the map lines identified in the map information.

For example, the vehicle control method may include an operation of performing the second data filtering based on comparing the sensor-based average lane width with the map-based average lane width.

For example, the vehicle control method may include an operation of performing the second data filtering based on a difference, by which the difference between the sensor-based average lane width and the map-based average lane width exceeds the first designated ratio, being greater than or equal to the designated number, or the difference between the sensor-based average lane width and the map-based average lane width exceeding the second designated ratio.

For example, the vehicle control method may include an operation of not performing the second data filtering based on a lane being the most side lane (e.g., the outermost lane) of a road if the difference, by which the difference between the sensor-based average lane width and the map-based average lane width exceeds the first designated ratio, is greater than or equal to the designated number, or the difference between the sensor-based average lane width and the map-based average lane width exceeds the second designated ratio.

In S607, the vehicle control method may include an operation of performing matching between the map information and the pieces of candidate line segment data, by applying a designated algorithm to pieces of candidate line segment data excluding pieces of filter line segment data filtered by the first data filtering and the second data filtering.

For example, the designated algorithm may include an ICP algorithm.

In S609, the vehicle control method may include an operation of controlling the operation of the vehicle by using a coordinate system expressing a location where the vehicle is driving, based on performing the matching.

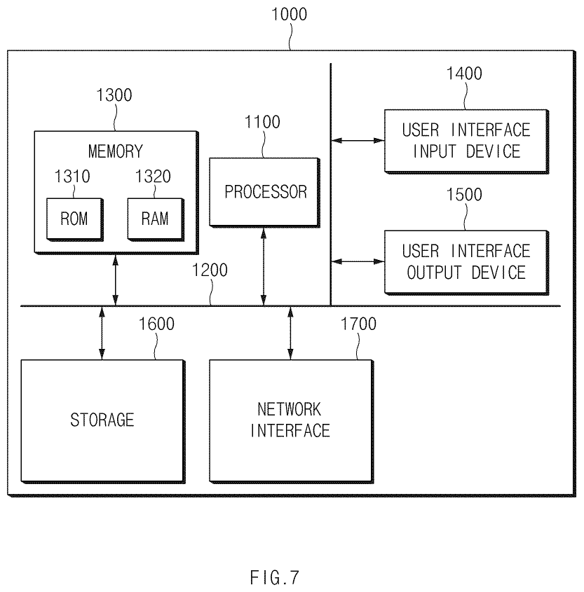

FIG. 7 shows a computing system associated with a vehicle control apparatus or vehicle control method.

Referring to FIG. 7, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to an aspect of the present disclosure, a vehicle control apparatus may include a camera, a memory in which map information is stored, and a processor. The processor may obtain pieces of line segment data associated with a line within an image obtained through the camera, may perform data filtering on at least one of the pieces of line segment data, or the map information, or any combination thereof based on a condition associated with at least one of an attribute, an angle, or a distance, or any combination thereof of each of the pieces of line segment data, may perform matching between the map information and the pieces of candidate line segment data, by applying a designated algorithm to pieces of candidate line segment data excluding pieces of filter line segment data and the map information based on deleting the pieces of filter line segment data filtered by the data filtering, and may control an operation of a vehicle based on performing the matching.

The processor may calculate a first width of a lane based on line segment lines identified by the pieces of line segment data, may calculate a second width of the lane based on map lines identified in the map information, and may determine whether to perform the data filtering, by comparing the first width with the second width.

The processor may perform the data filtering based on at least one of a type of each of the pieces of line segment data, a heading direction of each of the pieces of line segment data, a distance between the pieces of line segment data, a line identified if a lane on which the vehicle is driving is expanded, or a lane width, or any combination thereof.

The processor may perform the data filtering based on the type of each of the pieces of line segment data being different from a type of a map line identified in the map information.

The processor may identify partial line segment data among the pieces of line segment data, may identify a partial map line corresponding to the partial line segment data in the map information, and may perform the data filtering based on an angle between the partial line segment data and the partial map line exceeding a first designated angle.

The processor may identify pieces of partial line segment data among the pieces of line segment data, may identify partial map lines respectively corresponding to the pieces of partial line segment data in the map information, and may perform the data filtering based on an average value of angles between the partial map lines respectively corresponding to the pieces of partial line segment data and the pieces of partial line segment data exceeding a second designated angle.

The processor may perform the data filtering based on at least one of the pieces of line segment data and partial map lines identified in the map information being identified within a first designated distance by a designated number or more.

The processor may perform the data filtering based on identifying partial line segment data indicating that a distance between the vehicle and the map line exceeds a second designated distance if the lane is expanded, and a third designated angle is exceeded based on a forward-facing axis of the vehicle, from among the pieces of line segment data.

The processor may obtain a sensor average lane width by identifying a length between a reference point and the pieces of line segment data based on creating the reference point spaced apart from a left line of the vehicle by a third designated distance, may obtain a map average lane width by identifying a length between the reference point and map lines identified in the map information, and may perform the data filtering based on comparing the sensor average lane width with the map average lane width.

The processor may perform the data filtering based on a difference, by which a difference between the sensor average lane width and the map average lane width exceeds a first designated ratio, being greater than or equal to a designated number, or the difference between the sensor average lane width and the map average lane width exceeding a second designated ratio.

The processor may not perform the data filtering based on a lane being a most side lane of a road if the difference, by which the difference between the sensor average lane width and the map average lane width exceeds the first designated ratio, is greater than or equal to the designated number, or the difference between the sensor average lane width and the map average lane width exceeds the second designated ratio.

According to an aspect of the present disclosure, a vehicle control method may include obtaining, by a processor, pieces of line segment data associated with a line within an image obtained through a camera, performing data filtering on at least one of the pieces of line segment data, or map information stored in a memory, or any combination thereof based on a condition associated with at least one of an attribute, an angle, or a distance, or any combination thereof of each of the pieces of line segment data, performing matching between the map information and the pieces of candidate line segment data, by applying a designated algorithm to pieces of candidate line segment data excluding pieces of filter line segment data and the map information based on deleting the pieces of filter line segment data filtered by the data filtering, and controlling an operation of a vehicle based on performing the matching.

The vehicle control method may include calculating a first width of a lane based on line segment lines identified by the pieces of line segment data, calculating a second width of the lane based on map lines identified in the map information, and determining whether to perform the data filtering, by comparing the first width with the second width.

The vehicle control method may include performing the data filtering based on at least one of a type of each of the pieces of line segment data, a heading direction of each of the pieces of line segment data, a distance between the pieces of line segment data, a line identified if a lane on which the vehicle is driving is expanded, or a lane width, or any combination thereof.

The vehicle control method may include performing the data filtering based on the type of each of the pieces of line segment data being different from a type of a map line identified in the map information.

The vehicle control method may include identifying partial line segment data among the pieces of line segment data, identifying a partial map line corresponding to the partial line segment data in the map information, and performing the data filtering based on an angle between the partial line segment data and the partial map line exceeding a first designated angle.

The vehicle control method may include identifying pieces of partial line segment data among the pieces of line segment data, identifying partial map lines respectively corresponding to the pieces of partial line segment data in the map information, and performing the data filtering based on an average value of angles between the partial map lines respectively corresponding to the pieces of partial line segment data and the pieces of partial line segment data exceeding a second designated angle.

The vehicle control method may include performing the data filtering based on at least one of the pieces of line segment data and partial map lines identified in the map information being identified within a first designated distance by a designated number or more.

The vehicle control method may include performing the data filtering based on identifying partial line segment data indicating that a distance between the vehicle and the map line exceeds a second designated distance if the lane is expanded, and a third designated angle is exceeded based on a forward-facing axis of the vehicle, from among the pieces of line segment data.

The vehicle control method may include obtaining a sensor average lane width by identifying a length between a reference point and the pieces of line segment data based on creating the reference point spaced apart from a left line of the vehicle by a third designated distance, obtaining a map average lane width by identifying a length between the reference point and map lines identified in the map information, and performing the data filtering based on comparing the sensor average lane width with the map average lane width.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the present disclosure is provided to explain the spirit and scope of the present disclosure, but not to limit them, so that the spirit and scope of the present disclosure is not limited thereto. The scope of the present disclosure should be construed on the basis of the accompanying claims, and all the technical ideas within the scope equivalent to the claims should be included in the scope of the present disclosure.

The above description is merely an example of the technical idea of the present disclosure, and various modifications and modifications may be made by one skilled in the art without departing from the essential characteristic of the present disclosure.

Accordingly, one or more example embodiments of the present disclosure are not intended to limit but to explain the technical idea of the present disclosure, and the scope and spirit of the present disclosure is not limited by the above example embodiments. The scope of protection of the present disclosure should be construed by the attached claims, and all equivalents thereof should be construed as being included within the scope of the present disclosure.

The present technology may secure robust line map matching performance by filtering lines recognized by a camera.

The present technology may stably control the operation of a vehicle by filtering misrecognized lines and performing map matching.

Besides, a variety of effects directly or indirectly understood through the present disclosure may be provided.

Hereinabove, although the present disclosure was described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control apparatus comprising:
a camera;
a memory configured to store map information; and
a processor configured to:
obtain, via the camera, an image of an external environment of a vehicle;
determine one or more line segments associated with a traffic line in the image;
filter at least one of the one or more line segments or the map information, wherein the filtering is based on at least one of an attribute, an angle, or a distance of each of the one or more line segments;
compare the map information with candidate line segments, wherein the candidate line segments exclude filtered line segments from the one or more line segments; and
control, based on the comparison, an operation of the vehicle.

2. The vehicle control apparatus of claim 1, wherein the processor is configured to filter at least one of the one or more line segments or the map information by:
determining, based on the one or more line segments, a first width of a traffic lane;
determining, based on map lines in the map information, a second width of the traffic lane; and
filtering the at least one of the one or more line segments or the map information further based on comparing the first width with the second width.

3. The vehicle control apparatus of claim 1, wherein the processor is configured to filter at least one of the one or more line segments or the map information by:
filtering the at least one of the one or more line segments or the map information further based on at least one of: a type of each of the one or more line segments, a heading direction of each of the one or more line segments, a distance between the one or more line segments, a line of a widening traffic lane on which the vehicle is traveling, or a lane width.

4. The vehicle control apparatus of claim 1, wherein the processor is configured to filter at least one of the one or more line segments or the map information by:
filtering the at least one of the one or more line segments or the map information further based on a type of each of the one or more line segments being different from a type of a map line in the map information.

5. The vehicle control apparatus of claim 1, wherein the processor is configured to filter at least one of the one or more line segments or the map information by:
determining, among the one or more line segments, a partial line segment;
determining, based on the map information, a partial map line corresponding to the partial line segment; and
filtering the at least one of the one or more line segments or the map information further based on an angle between the partial line segment and the partial map line exceeding a threshold angle.

6. The vehicle control apparatus of claim 1, wherein the processor is configured to filter at least one of the one or more line segments or the map information by:
determining, among the one or more line segments, partial line segments;
determining, based on the map information, partial map lines respectively corresponding to the partial line segments; and
filtering the at least one of the one or more line segments or the map information further based on an average value of angles between the partial map lines and the partial line segments exceeding a threshold angle.

7. The vehicle control apparatus of claim 1, wherein the processor is configured to filter at least one of the one or more line segments or the map information by:
filtering the at least one of the one or more line segments or the map information further based on at least a threshold quantity of the one or more line segments being within a threshold distance from respective partial map lines in the map information.

8. The vehicle control apparatus of claim 1, wherein the processor is configured to filter at least one of the one or more line segments or the map information by:
filtering the at least one of the one or more line segments or the map information further based on:
a lane on which the vehicle is traveling being widening,
a distance between the vehicle and a map line in the map information exceeding a threshold distance, and
partial line segments, of the one or more line segments, exceeding a threshold angle relative to a longitudinal axis of the vehicle.

9. The vehicle control apparatus of claim 1, wherein the processor is configured to filter at least one of the one or more line segments or the map information by:
determining, based on a distance between a reference point and the one or more line segments, a sensor-based average lane width, wherein the reference point is a threshold distance away from a left traffic line of the vehicle;
determining, based on a distance between the reference point and map lines in the map information, a map-based average lane width; and
filtering the at least one of the one or more line segments or the map information further based on comparing the sensor-based average lane width with the map-based average lane width.

10. The vehicle control apparatus of claim 9, wherein the processor is configured to filter at least one of the one or more line segments or the map information by:
filtering the at least one of the one or more line segments or the map information further based on:
a difference between the sensor-based average lane width and the map-based average lane width exceeding a first threshold ratio by at least a threshold margin, or
the difference between the sensor-based average lane width and the map-based average lane width exceeding a second threshold ratio.

11. The vehicle control apparatus of claim 1, wherein the processor is further configured to:
based on a difference between a sensor-based average lane width and a map-based average lane width exceeding a first threshold ratio by at least a threshold margin or exceeding a second threshold ratio, and further based on a traffic lane on which the vehicle is traveling being an outermost lane of a road, controlling the operation of the vehicle based on the one or more line segments or the map information.

12. A vehicle control method comprising:
obtaining, by a processor and via a camera, an image of an external environment of a vehicle;
determining one or more line segments associated with a traffic line in the image;
filtering at least one of the one or more line segments or map information stored in a memory, wherein the filtering is based on at least one of an attribute, an angle, or a distance of each of the one or more line segments;
comparing the map information with candidate line segments, wherein the candidate line segments exclude filtered line segments from the one or more line segments; and
controlling, based on the comparison, an operation of the vehicle.

13. The method of claim 12, wherein the filtering of at least one of the one or more line segments or the map information comprises:
determining, based on the one or more line segments, a first width of a traffic lane;
determining, based on map lines in the map information, a second width of the traffic lane; and
filtering the at least one of the one or more line segments or the map information further based on comparing the first width with the second width.

14. The method of claim 12, wherein the filtering of at least one of the one or more line segments or the map information comprises:
filtering the at least one of the one or more line segments or the map information further based on at least one of: a type of each of the one or more line segments, a heading direction of each of the one or more line segments, a distance between the one or more line segments, a line of a widening traffic lane on which the vehicle is traveling, or a lane width.

15. The method of claim 12, wherein the filtering of at least one of the one or more line segments or the map information comprises:
filtering the at least one of the one or more line segments or the map information further based on a type of each of the one or more line segments being different from a type of a map line in the map information.

16. The method of claim 12, wherein the filtering of at least one of the one or more line segments or the map information comprises:
determining, among the one or more line segments, a partial line segment;
determining, based on the map information, a partial map line corresponding to the partial line segment; and
filtering the at least one of the one or more line segments or the map information further based on an angle between the partial line segment and the partial map line exceeding threshold angle.

17. The method of claim 12, wherein the filtering of at least one of the one or more line segments or the map information comprises:
determining, among the one or more line segments, partial line segments;
determining, based on the map information, partial map lines respectively corresponding to the partial line segments; and
filtering the at least one of the one or more line segments or the map information further based on an average value of angles between the partial map lines and the partial line segments exceeding a threshold angle.

18. The method of claim 12, wherein the filtering of at least one of the one or more line segments or the map information comprises:
filtering the at least one of the one or more line segments or the map information further based on at least a threshold quantity of the one or more line segments being within a threshold distance from respective partial map lines in the map information.

19. The method of claim 12, wherein the filtering of at least one of the one or more line segments or the map information comprises:
filtering the at least one of the one or more line segments or the map information further based on:
a lane on which the vehicle is traveling being widening,
a distance between the vehicle and a map line in the map information exceeding a threshold distance, and
partial line segments, of the one or more line segments, exceeding a threshold angle relative to a longitudinal axis of the vehicle.

20. The method of claim 12, wherein the filtering of at least one of the one or more line segments or the map information comprises:
determining, based on a distance between a reference point and the one or more line segments, a sensor-based average lane width, wherein the reference point is a threshold distance away from a left traffic line of the vehicle;
determining, based on a distance between the reference point and map lines in the map information, a map-based average lane width; and
filtering the at least one of the one or more line segments or the map information further based on comparing the sensor-based average lane width with the map-based average lane width.
